(19) United States
(12) Patent Application Publication
(10) Pub. No.: US 2012/0109763 A1
(43) Pub. Date: May 3, 2012

(54) Mobile Charging of Electric Vehicles Off the Electric Power Grid

(76) Inventor: Lisa Mae Laughner, Indianapolis, IN (US)

(21) Appl. No.: 13/279,269

(22) Filed: Oct. 22, 2011

Related U.S. Application Data
(60) Provisional application No. 61/409,175, filed on Nov. 2, 2010.

(51) Int. Cl. G06Q 20/20; H02J 7/00

(52) U.S. Cl. 705/17; 320/109; 320/137

(57) ABSTRACT

A system and method are disclosed that provide mobile electric power to one or more electric vehicles without drawing electricity from the electric power grid. The system may include a transportation vehicle, a combustion engine coupled to an electric generator, and a controls box coupled to the generator to transmit electricity to an electric vehicle or storage batteries.

### RELATED APPLICATION

This application claims priority from U.S. Provisional Application No. 61/409,175 (filed Nov. 2, 2010), the disclosures of which are incorporated by reference.

### BACKGROUND

The present disclosure generally relates to mobile charging of electric vehicles off the electric power grid.

The charging of electric vehicles at a residence may involve drawing electricity from the electric power grid through a 220 volt docking station that couples to the electric vehicle via an electric vehicle industry standard connector or by a 110 volt standard plug “trickle charge.” Public charging stations for electric vehicles, which also draw electricity from the electric power grid, provide 220 volt charging to electric vehicles. Fast charging using 480 volts and converting to DC may be available in the future. These electric vehicle charging solutions require the electric vehicle to be parked in close proximity to the charging equipment.

The problem with charging electric vehicles by using electricity provided by the power grid is the significant load demand it places on the grid. The electric power grid is publically known to be fragile, and subject to blackouts or brownouts. To manage the electric vehicle charging demand, electric vehicle manufacturers and electric utilities are recommending that vehicles be charged at night when electricity demand is at its lowest. However, it has been reported that even as few as two or three electric vehicles “plugged” in at night could cause blackouts as the neighborhood transformers break down from the high electric load demands. Charging electric vehicles during the day, when electricity demand is at its peak, puts tremendous strain on the electric power grid, potentially causing blackouts and also requiring utilities to produce additional power supply at peak load pricing to the consumer.

Electric utilities are faced with a major upgrade to the grid to accommodate the future power demand from electric vehicles. It has been estimated that an upgrade to the USA power grid could be as high as $900 billion to ensure reliable power for charging electric vehicles day or night. This investment is a significant problem for utilities and also consumers who eventually pay for power grid infrastructure through their utility bills.

Another problem is the inability of the residence or public charging station to provide charging to electric vehicles if those vehicles have run out of electric power while they are on the road. Residential and public charging solutions couple to the electric power grid to provide electricity to the electric vehicles, and therefore are not mobile. If an electric vehicle runs out of power while on the road, it cannot get to a residential or public charging station. Currently, most electric vehicles have much smaller range than conventional gasoline/diesel automobiles, and limited electric vehicle public charging infrastructure exists in the USA. On long road trips, electric vehicle owners have “range anxiety”; this is anxiety due to the vehicle's reduced range and limited availability of public charging stations.

What is needed is a mobile electric vehicle charging solution that provides efficient and reliable electric power for electric vehicles without drawing power from the power grid, regardless where the electric vehicle resides, in a manner that is convenient to the electric vehicle owner's needs.

### SUMMARY

One exemplary embodiment of the disclosed subject matter is a novel mobile electric vehicle charging solution that does not draw power from the electric power grid, thereby eliminating the threat of blackouts, peak load pricing, and the need for an electric power grid upgrade due to electric vehicle charging demand. The present invention provides reliable and environmentally friendly electric power to one or more electric vehicles in a convenient manner to the vehicle owner(s) and is mobile. The present invention can travel to the electric vehicle and charge the vehicle regardless where that electric vehicle resides. Moreover, the system of the present invention may provide power to a bank of storage batteries.

The present invention includes a method and a system designed to provide electric power to one or more electric vehicles, without drawing electricity from the electric power grid. The system is mobile, and can travel to an electric vehicle. The system is capable of supplying power to one or more electric vehicles, and alternatively to storage battery packs. The system includes a transportation vehicle, a fuel source, a combustion engine coupled to an electric generator, a controls box, one or more coupling adapters that connect to electric vehicles, and optional storage batteries. The fuel source may include natural gas or alternatively LP gas, propane, diesel, or gasoline. The fuel source may be supplied by the transportation vehicle's fuel tank or an auxiliary storage tank. The electric generator may be capable of providing 110 volt, 220 volt, or 480 volt single phase or three phase electric power at 50 hertz or 60 hertz frequency. The controls box is capable of commanding various power levels from the generator. The controls box includes hardware and software such as timers, switches, breakers, and electronics that start and stop the system, communicate with the electric vehicle's power system electronics, convert the power from AC to DC or DC to AC, and transmits electric power to the electric vehicle, or the storage batteries. The controls box also contains hardware and software that accommodate the public purchase of the electricity produced by the power system.

The present invention reliably provides electric power to an electric vehicle without drawing electricity from the power grid. Moreover, when the method of electric generation includes a natural gas fuel source, the generation of said electricity is environmentally friendly because the system produces substantially less carbon dioxide and other pollutants than the same amount of electricity produced from a coal-fired utility.

### BRIEF DESCRIPTION OF THE DRAWINGS

Some non-limiting exemplary embodiments of the disclosed subject matter are illustrated in the following drawings. Identical or duplicate or equivalent or similar structures, elements, or parts that appear in one or more drawings are generally labeled with the same reference numeral, optionally with an additional letter or letters to distinguish between similar objects or variants of objects, and may not be repeatedly labeled and/or described. Dimensions of components and features shown in the figures are chosen for convenience or clarity of presentation. For convenience or clarity, some elements or structures are not shown or shown only partially and/or with different perspective or from different point of views.

FIG. 1 is a block diagram of an embodiment of the disclosed subject matter illustrating a system for mobile charging of electric vehicles.

### DETAILED DESCRIPTION

A general problem with charging electric vehicles by using electricity provided by the power grid is the significant load demand it places on the grid. A general solution is to charge electric vehicles at the roadside without using electricity provided by the grid.

A technical problem in the field of charging electric vehicles is providing reliable and environmentally friendly electric power to one or more electric vehicles in a convenient manner to the vehicle owner(s). A technical solution includes a method and a system designed to provide mobile electric power to one or more electric vehicles, without drawing electricity from the electric power grid. The system may include a transportation vehicle, a fuel source, a combustion engine coupled to an electric generator, a controls box, one or more coupling adapters that connect to electric vehicles, and optional storage batteries.

A general nonlimiting overview of practicing the present disclosure is presented below. The overview outlines exemplary practice of embodiments of the present disclosure, providing a constructive basis for variant and/or alternative and/or divergent embodiments, some of which are subsequently described.

The present invention includes a method and a system for providing mobile electric power to an electric vehicle. The system generates its own electric power and provides that power to the electric vehicle. The system may also provide its generated electric power to storage batteries. Because the system avoids the need to draw electricity from the electric power grid, it does not put demand strain on the electric power grid, leading to blackouts or brownouts. Moreover, the system is mobile, and can travel to an electric vehicle to provide roadside charging.

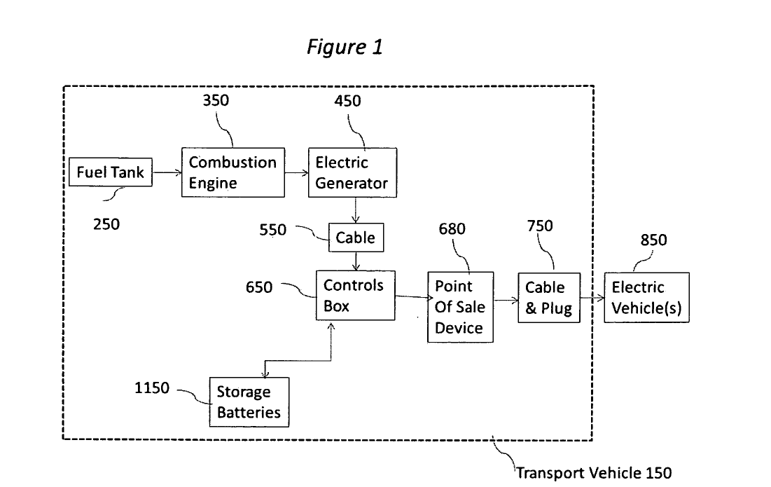

As illustrated in FIG. 1, the system of the present invention is a mobile charging solution for electric vehicles. The present invention may comprise a transportation vehicle 150 such as a truck, van, or utility trailer. The system may comprise a fuel tank 250. The fuel source may be natural gas, LP gas, propane, diesel fuel or gasoline. The fuel tank 250 provides the fuel to the combustion engine 350 which is coupled to an electric generator 450 via a coupling shaft. The size of the combustion engine 350 and electric generator 450 varies depending on the rate of electric power charging for the electric vehicle(s) 850. The electric generator 450 is capable of producing 110 volt, 220 volt or 480 volt single or three phase AC electricity at 50 hertz or 60 hertz frequency. The electricity generated is transmitted to the controls box 650 via a cable 550. The controls box 650 performs the functions of starting and stopping the system, communicating with the electric vehicle(s) 850, conditioning and transmitting AC or DC power to the electric vehicle, and optionally switching the power to be made available to the storage batteries 1150. The controls box 650 includes one or more cables and plugs 750 which connect to the electric vehicles and transmits the electricity that charges the electric vehicle's batteries. The controls box 650 may include transfer switches that interface to a bank of storage batteries 1150. This interface allows the system to store electric power in the batteries 1150. The controls box 650 contains hardware and software (not shown) which allows communication with the electric vehicle(s) 850, and communication with the electric generator 450 and combustion engine 350. The controls box 650 may contain point of sale hardware and software 680 which allows for credit or debit card transactions to accommodate the sale of the generated electricity to the electric vehicle owner.

In operation, the provider drives or transports the mobile charging solution to the electric vehicle. The provider may swipe the electric vehicle owner's credit or debit card in a card reader integrated in the point of sale device 680, select the amount of electricity to be provided to the electric vehicle 850 and connect the cable 750 to the electric vehicle 850. Alternatively, the provider may bill the electric vehicle owner via a subscription or other method of payment. The controls box 650 signals the combustion engine 350 to start operating the electric generator 450. The combustion engine's coupling shaft is coupled to the electric generator 450 and rotates, causing the electric generator to produce electricity. The electricity is transmitted to controls box 650 via a cable 550 and the controls box then transmits the electricity to the electric vehicle via cable 750. Once the electric power has been delivered to the electric vehicle 850, the provider disconnects the cable 750 and the point of sale transaction completes between the vehicle owner's credit card and the provider. Alternatively, the controls box 650 may signal the storage batteries 1050 to provide the electric power for the electric vehicle 850. While certain embodiments have been described, these embodiments have been presented by way of example only, and are not intended to limit the scope of the inventions. Indeed, the novel devices and methods described herein may be embodied in a variety of other forms; furthermore, various omissions, substitutions, and changes in the form of the devices and methods described herein may be made without departing from the spirit of the inventions. The accompanying claims and their equivalents are intended to cover such forms or modifications as would fall within the scope and spirit of the inventions.

1. A system for mobile charging electric vehicles off the electric power grid, the system comprising:
a transportation vehicle;
an engine;
an electric generator coupled to the engine; and
a controls box in communication with the electric generator and a vehicle, wherein the controls box is configured to supply electricity to the vehicle.

2. The system according to claim 1 wherein the controls box is also in communication with storage batteries to condition and supply electricity to the storage batteries.

3. The system according to claim 2 wherein the controls box is also in communication with a point of sale device configured to accommodate credit and debit card purchases of electricity.

4. The system according to claim 1 wherein the electric generator is a three phase generator capable of providing varying voltage outputs.

5. The system according to claim 1 wherein the controls box includes hardware and software to condition electric power before being transmitted to the vehicle.

6. A method for mobile charging electric vehicles off the electric power grid, the method comprising:
employing a vehicle;
employing an engine powered by a fuel source;
coupling the engine to an electric generator to generate electricity; and
coupling a controls box in communication with the electric generator and a vehicle, wherein the controls box is configured to supply electricity to the vehicle.

7. The method according to claim 6 wherein the controls box is also in communication with storage batteries to supply electricity to the storage batteries.

8. The method according to claim 6 wherein the controls box is also in communication with a point of sale device configured to accommodate credit and debit card purchases of electricity.

9. The method according to claim 6 wherein the electric generator is a three phase generator capable of providing varying voltage outputs.
